(19) United States
(12) Patent Application Publication
(10) Pub. No.: US 2005/0003839 A1
(43) Pub. Date: Jan. 6, 2005

(54) Decision influence data system

(76) Inventor: Jeffrey William Tripp, Annandale, NJ (US)

Correspondence Address: IP DEPARTMENT OF PIPER RUDNICK LLP, ONE LIBERTY PLACE, SUITE 4900, 1650 MARKET ST, PHILADELPHIA, PA, 19103, US

(21) Appl. No.: 10/842,822

(22) Filed: May 11, 2004

Related U.S. Application Data
(60) Provisional application No. 60/469,903, filed on May 13, 2003.

(51) Int. Cl. H04N 1/00

(52) U.S. Cl. 455/466

(57) ABSTRACT

A means/product seamlessly gathers and retains data for consumer products and services to enable e-commerce in handheld devices. Data is available at the product and rich enough in content to provide details about the product or service for use in the purchasing decision of the consumer or immediately allow access to additional information through a wireless connection. In one embodiment, the solution utilizes RFID tag technology.

### CROSS-REFERENCE TO RELATED APPLICATIONS

The present application claims priority of U.S. Provisional Patent Application Ser. No. 60/469,903 filed May 13, 2003, the entire disclosure of which is incorporated by reference herein.

### BACKGROUND OF THE INVENTION

The first generation of the RFID technology is relatively simple, as the technology has focused on security entry points that require little information exchange to occur. As the next generation of devices is being prepared, the level of complexity of the devices has increased and allows for more sophisticated devices to be manufactured inexpensively. Currently, there is a growing industry push to use these devices in manufacturing and retail establishments to improve product tracking, provide real-time manufacturing information, and monitor inventories. There exists other applications for this technology that complements the efforts of the retailers and enables efficient electronic/mobile commerce (e-commerce) opportunities. This application provides consumers (or handheld users) with valuable point of service information and will support the retailers' efficiency goals and the manufacturers brand awareness, while providing technical simplicity and helping to create more value for RFID devices by creating the broadest application of the technology that is possible. Creating and leveraging new information portals is the next evolution in the development of the Internet and this proposed concept/application is positioned at the forefront of the next generation solutions.

It is proposed to create a product and service to leverage the deployment of the next generation RFID tags and provide consumers with a simple, affordable, and interactive wireless data link to download product specifications or information to handheld devices seamlessly, while providing retailers with an efficient mode of e-commerce.

### SUMMARY OF THE INVENTION

Consumers have many handheld devices available that can be used to store data and information or access information remotely. Unfortunately, the ability of these devices to access data can be cumbersome or limited, either from poor performing wireless data links or from general proximity to an Internet browser.

Solutions to address this include adding alternative wireless links to access data (Internet) remotely to downloading data ahead of time for retrieval when the information is needed. These solutions, though elegant, have limitations themselves, one of which is real-time, local and accurate information. Today, this information is stored in a detached way for close association for the consumer to use effectively or the information does not have enough detail to prove effective. If more information was immediately and seamlessly available for the consumer, this data could be used to provide details about products, enhance services, or provide directions. Having this information would create more awareness for the consumer and allow for faster purchasing decisions to be made.

There are many forms of information available with products today that are useful. For example, virtually every product has adopted UPC codes. While these codes have proven valuable to merchandisers to expedite transactions and maintain inventories, the codes themselves are limited in information content. The code does not contain any specific product information that is useful to the consumer. Granted, the consumer could use this code to gain knowledge or information about the product, but this can only be accomplished in a convoluted way.

Of course, product merchandising has become quite an art and provides substantial information for many products. Sophisticated packaging and printing to capture the eye of the consumer is effective and elegant. Alas, this information is limited to what is available at the time of printing for any product. If a mechanism could be created to enhance this merchandising and provide additional information or new information, the consumer and the retailer would benefit. The retailer and manufacturer would now create a higher potential sale with current point of sale information and the consumer would be able to make a more confident purchase. For example, if a consumer had data from a trusted agency, at the point of sale, this would provide the level of information required to make the purchase. Today this is handled with print material for the most part or kiosk displays.

As for other sources of information, wireless connectivity allows for access to information contained on the Internet, but is often too slow, cumbersome or inconsistent for use in a retail outlet. For many consumers who use the Internet to make their final purchasing decision, bringing some of this information to the point of sale would benefit both the consumer and in the end, the retailer. Whether it is reading reviews of the products or comparison ratings or providing the consumer with detailed information about the product for later consideration, having the information at the purchase point can only enhance the experience for the consumer in their purchasing quest. Other more traditional forms of media, such as newspapers and magazines often prove to be inconvenient or forgotten, thus postponing purchasing decisions. Allowing products to be updated with this latest information can assist the product marketing teams in point of sale advertising and provide a new tool in their quest to optimize the product flow through the channels.

This information sourcing technique is not limited to strictly products, either. For example, in the services area such as a mall map, the kiosk is often inconvenient or is difficult to remember or determine actual locations. Of course there are many signboards, kiosks and flyers available to address these needs, but these do not help in determining a specific location. Using devices such as an RFID could enhance this view. Allowing the consumer to first read a mall map and then having reader locations throughout the mall would allow immediate location detection for the consumer and would allow the consumer to determine directions to a new location desired within that space.

The applications for this technology could be substantial. Creating a richer source of information at the point of interest through the use of handheld devices provides a business opportunity. The devices themselves are becoming more sophisticated allowing this to occur, but the consumer will need the ability to tap into this potential information with new modules integrated with or into their existing handheld devices, along with applications/clients for those devices. These coupled with carrier/network interface software and database management software can enable a new marketing method as never used before.

### BRIEF DESCRIPTION OF THE DRAWINGS

FIG. 1 is an exemplary diagram in accordance with an embodiment of the present invention.

FIG. 2 is an exemplary diagram in accordance with an embodiment of the present invention.

FIG. 3 is an exemplary diagram in accordance with an embodiment of the present invention.

FIG. 4 is an exemplary block diagram in accordance with an embodiment of the present invention.

FIG. 5 is an exemplary block diagram in accordance with an embodiment of the present invention.

FIG. 6 is an exemplary block diagram in accordance with an embodiment of the present invention.

FIG. 7 is an exemplary block diagram in accordance with an embodiment of the present invention.

### DETAILED DESCRIPTION

The following introduces a concept for information gathering and applications for its use. The information is focused on products, although, there are service applications and business opportunities also available, as previously discussed. In general, the use of existing technological devices is used in a new way creating a novel device and application.

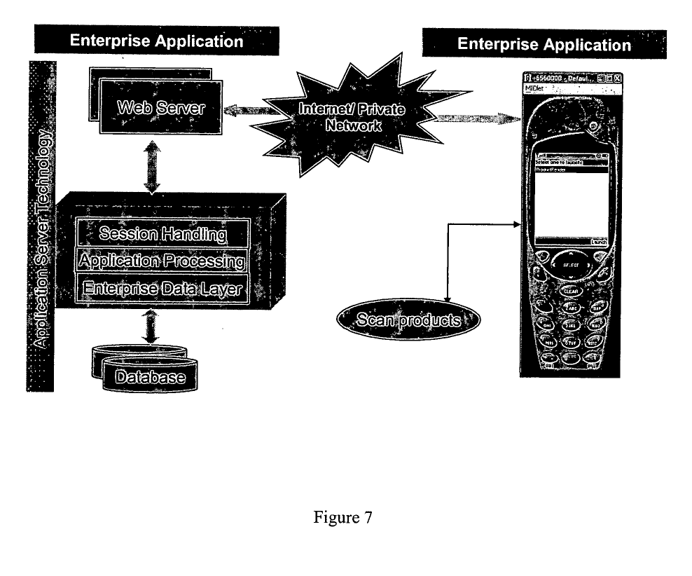

It is proposed to introduce a means/product to seamlessly gather and retain data for consumer product and services to enable e-commerce in handheld devices. Data would be immediately available at the product and be rich enough in content to provide details about the product or service for use in the purchasing decision of the consumer or immediately allow access to additional information through a wireless connection. The proposed solution would tap into the emerging RFID tag technology. The consumer would either purchase add-on products for wireless products such as PDA's, (portable handheld devices) and cellular phones or purchase a handset with access capability included (referred to as modules in both cases). The modules would interface directly to these handheld devices, tapping into an already embedded base. The consumer, on demand, would operate the devices/reader. This would be accomplished by having the consumer approach a product of interest and wave their handheld device near the product to extract the information provided. The data would be loaded into the handheld unit for review, storage, or seamless data access through a wireless data link as shown in system diagram of FIG. 7. The transaction is simple and efficient, but yet provides information to the consumer that could be valuable in making a purchase, at the point of sale.

Manufacturers or retailers would embed/attach RFID tags into their products. As the devices are programmable, either the retailer or the manufacturer could modify the contents of the device to provide up to date information about a product that would be useful to the consumer on top of the baseline information such as product features, model numbers, etc. In fact, the RFID tags memory can be scaled to provide increasing content for more sophisticated or expensive items. Additionally, the client software would also create a data link, allowing the consumer to immediately access more information. All of this would take place automatically, after the consumer decides to look for additional information. Reading one or more RFID tags to create and set up links for store or product information.

The consumer could use this information in several ways. First, the consumer could review the content at the point of sale. This additional information may provide enough data to give the consumer confidence in making an immediate purchase. Second, the consumer could carry the information away from the point of sale to more effectively conduct research or to share the information with other consumers, providing the retailer and manufacturers with a new point of marketing. Third, it provides a reminder to the consumer and keeps a product and retailer at the forefront of the decision making process, creating a valuable tool for the reseller. Fourth, the consumer can now create a history of their purchases and provide a path for retailers to earn possible repeat purchases from those consumers. The information can be either the data retrieved directly from the RFID tag or from the information gained through the wireless data link.

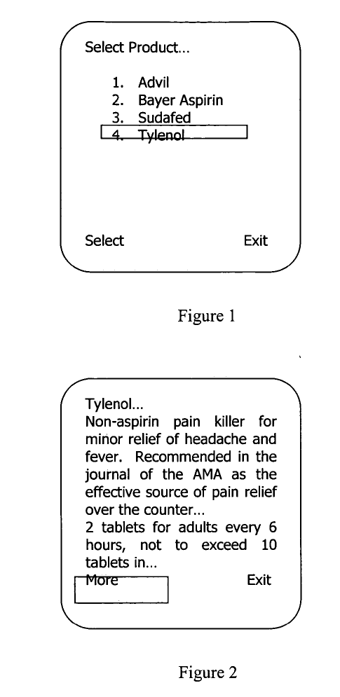

As an example, imagine a consumer purchasing a medicinal product as described for example by the system diagram of FIG. 7 and refined in FIG. 1. Much information is available on the package, but the consumer may like to see if additional information is available through their wireless access point. As the consumer faces the products and initiates an access through their Cellular phone, the handheld detects products with RFID tags and displays the content, either through information contained on the tag or link information on the tag or through a software client on the handheld that looks up coded information through a non-resident database. The choices in this case are 1-4 with associated product name as shown in FIG. 1.

The user is allowed to make a selection through a mechanism such as a scroll bar to select an item as shown by the rectangle in FIG. 1. After the consumer scrolls to their choice (or selects the appropriate number) of product and makes a selection, additional information would then be displayed. This information can be contained in the RFID tag itself or through the internet link and is immediately available to the consumer as is shown in FIG. 2.

If this information is not rich enough in content to provide enough detail to the consumer, additional information could become available. As the consumer was accessing the RFID information, the client software read the RFID tag and obtained data that allows the client software to seamlessly negotiate through the wireless link to address additional information. The handheld device for example, could have previously acquired any retail store information and stored it along with the product information to create the appropriate link. As soon as the consumer chooses to gather “more” information, the wireless device would immediately produce the next screen, without invoking a browser function, without searching the internet, without keying in a product code. This is represented in the example in FIG. 2, where the scroll bar was moved to the position over more and then select with, for example, an okay button on the handheld.

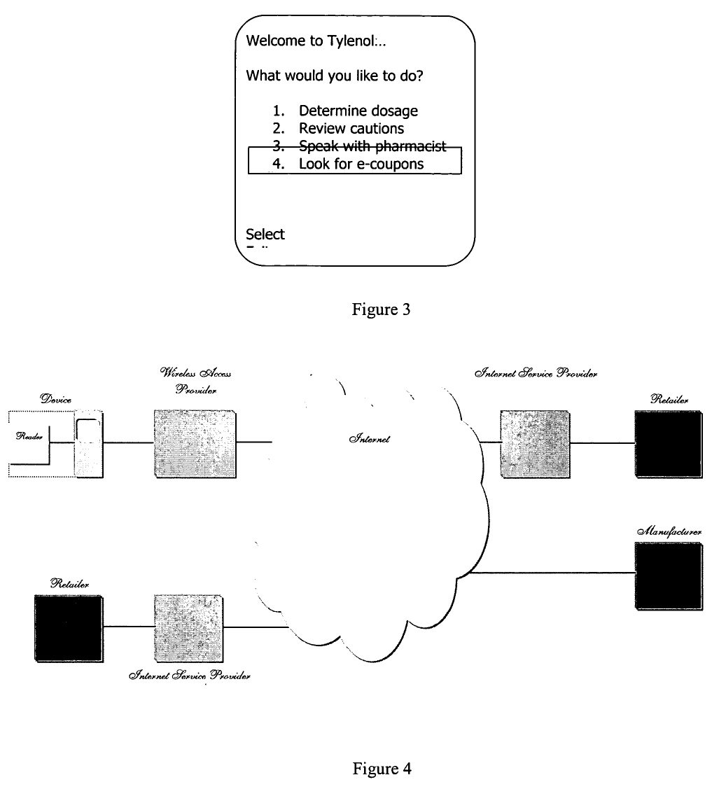

Now the handheld user can move to different levels of interaction depending on their specific need as shown in FIG. 3, for example. The latest wireless technologies can support this new feature. For example, if the consumer selected option 3 from FIG. 3, not only would an audio link be established, but this could actually allow for a video call upon selection. Imagine not only contacting a pharmacist, but actually look at them as they explained an answer to the consumers' question. This is a powerful tool that could be used to create brand awareness while accentuating customer service capabilities. Further, if a consumer selected option 4 as shown in FIG. 3, e-coupons, the manufacturer could make discounts immediately available to repeat customers or for promotional items. The consumer could then take this information to the retail check out lane and transfer the e-coupon electronically into the system or have a barcode read from the display of their device to obtain an immediate discount. The manufacturer has a direct target to the purchaser and could even enhance the information with advertisements on other products creating the opportunity to sell higher tiered products or to bundle more products to enhance their sales. This instantaneous interaction is novel as it is created through links created from RFID information. Looking up the information, connecting it to the user and providing a marketing path are unique in this application of technology.

This is a very powerful new direct marketing tool for the manufacturers and retailers, but unobtrusive to the traditional consumer as they initiate the entire transaction. The same system used to read the tags on the shelf could be duplicated at the check out register, such that the consumer could now pay for their purchases through a wireless access on their phone and conduct the entire transaction wirelessly.

This example shows the power of creating a system that has local content immediately available. The number of products this can be applied to is limitless. Not only can the consumer tap into the RFID information, but the retailer can use the same devices to track inventory and locate specific products. Of course the consumer could also do this. Imagine this system could be used to determine if a specific size pair of pants was on the rack before the search of the rack begins. How many times does one look through a pile of clothes, only to find that your size just isn't there? Now a quick scan can be made to determine that indeed it does exist. In fact, this technology could be used to scan the general vicinity of where the exact pair of pants can be found. This is a powerful tool for not only the manufacturers, but also for the consumers. Using a portable handheld device to search for items at the consumer level is unique.

Another interesting thing about this technology is how the retailer/manufacturers can use the RFID tag. Imagine if a positive review comes out about a product. Imagine being able to take the reference and some of the information and immediately imbed the information with the product. No more waiting for marketing material to be printed or stickers to be added to a product. Just dial into the access points and re-program the RFID tag with the new content. This could happen in minutes and the consumer would then have the most relevant information available to make a decision. On top of that, a new link selection could be created within a RFID tag, to direct the consumer to the location of the latest review.

The retailer and manufacturer would now have at their disposal, a powerful new marketing tool. Now that information can be updated in real-time for the consumer, marketing teams can test different forms of content at the point of sale to sway the thoughts of the consumer.

Applications that use this type of solution are endless. From sophisticated products like a car, that may require more information to explain a product to simply reading date codes on a milk carton. The content and the sophistication of the RFID devices would vary across applications as needed. In this way, the RFID tag and reader can then be scaled to the application, for cost or content specific requirements.

This e-commerce method would design RFID readers to be integrated or added onto portable handheld devices. This would expand the handheld users choices and have solutions available in many forms such as mobile phones, personal PDA's, Audio/MP3 players.

Other Applications

Adding tags to wine bottles for example could assist the consumer in determining the best selection for their tastes. For instance, the wine tag could contain information pertaining to the grapes used, region produced, year produced, rating from the wine spectator magazine, description of taste, suggestions for complimentary foods, history of the winery and its website while loading all of this into electronic memory for review, sharing, retrieval, and return purchases. The automated link could access the retail outlets inventory list and contain cross references based upon similar tasting wines, similarly priced wines, wines in stock, or information about volume discounts at the store. Data could be stored in either the tag or database in any configuration or order. The tags would optimally be placed, but not limited to, onto the wine bottles by the manufacturer (or the distributor or the retailer/wholesaler—merchant) as the wine is originally produced, allowing enough memory expansion to add information as the wine bottle travels through the wine making process, through distribution, to the retail outlet and finally into the customers hands. Also, this provides an interesting marketing position for the industry, as many wines mature/improve over time this information can be captured and entered into the RFID tag or linked database of any specific wine bottle.

There are so many variations and features designed into automobiles it is often difficult to remember and difficult to compare vehicles and prices. If the consumer had a reader module available, then information could be obtained directly from the sticker such as price, features, and specifications for comparison and review. The information could be useful to the dealer also, as they could embed information pertaining to the dealership such as website, phone number, and hours of operation. Additional links could allow the consumer to understand similar vehicles in stock or point to industry reports on safety and quality.

As a service, mall maps could be downloaded and then locators at every entry point could provide a consumer with instant location information within the mall, provide a list of retailers within the mall, and directions to a specific retailer. Each retailer would have RFID tags that would be programmed with useful information pertaining to the store such as phone number, website, and hours of operation. Additional information could be added such as if an employment opportunities were available at a location, for example. Not to mention the plethora of products in the store for a consumer to access and possible sale information. It would be interesting to have a search taking place in a handheld device that when detected, would indicate a sale taking place for a specific name brand or item. The information could be loaded into list and vary in size depending upon the RFID device itself. This would provide privacy for the consumer that chooses to disable the reader function and not be bothered by store advertisements or specials.

Another service and product is for real estate. Today there is rich information about real estate on the Internet, except how much of this is available to potential home buyers as they drive their vehicle past a home for sale? Also, how many consumers have driven past a property only to find all the fliers gone (presumably taken by curious neighbors, no doubt)? Adding RFID tags to the signs and providing a reader module to the consumer in a handheld device would provide details pertaining to the property such as square footage, number of rooms, schools, etc. or provide information about the real estate company. The information would be loaded by the retailer when the sign is installed and updated as necessary. The virtual flier is always available with immediate information for the would-be purchaser.

The following list is not complete, though these applications can easily be developed and defined to fit within the system.

Audio samples—listen to samples prior to CD purchase

Video samples—listen and view video clips before purchase or rental

Museum tours—subscribe and then create a listening tour of the museum items of interest

Magazine samples—view magazine sample text, features or photo's before purchasing

Book samples—view text samples, listen to audio book sample

Pharmacy—assist elderly patients with larger text for reading or identify prescriptions/medications, provide additional information or immediately cross reference medications

Video game—Sample screen shots and demonstrations

Grocery store—acquisition of date codes and freshness or possible pricing information

A tremendous benefit of this system is that it can be scaled with the sophistication and cost of the products. That is to say, more content may be desired for more sophisticated products. For example, an automobile may require more information and therefore a larger memory device. The scale of the vehicle compared to the cost of the device is insignificant in this case and should not be considered material as the content is more important then the cost.

The important thing for any application is to provide additional content and allow for location proximity to read the tags. Creating a reader space that is too large will be confusing to the consumer and possibly consume more power in the handheld device module. It is necessary to balance the performance and capabilities of the reader, while offering broad functionality is vital to the success of any product in this market space.

Other Methods

It is important to understand that benefits of this technology may not only be obtained through the use of RFID tags. The use of these tags is the preferred implementation as it provides a non-line-of-sight access for the consumer and therefore the most reduced form of consumer intervention and greatest possible use. These business concepts can be used in other forms to accomplish similar results, though the ability to influence the point of sale purchase through an electronic method such as this is unique to this business. For example, with greater user participation, the user could go to a number code written on a product and enter information manually through the keypad or audibly through voice processing/detection. In another example, it is possible to leverage capabilities from a digital camera (now becoming available in the handheld market). In this form, the user could snap a picture of a bar code, for example, and have an application in the handheld process the image to extract the appropriate data to access additional information. As in the manual data entry, the Consumer would be required to locate the bar code and take the picture to capture the information. In both of these methods, it is difficult to completely replicate the advantages of the wireless tag solution and access, as the consumer must participate in first obtaining the information and then engaging the system. With wireless tags, all of this is completed in the background and provides for seamless connections to be created within the handheld device. Further, the wireless tags, allow for pre-configuring (pre-reading or reading multiple tags for content and concatenating information for display or linkages) access and data reducing any inherent delays in the system that the consumer may normally encounter producing a much more sophisticated experience that appears more convenient and intuitive.

Technology

To implement this concept, the following areas are now connected.

1) Reader and the associated content in the RFID tag.

2) Client software residing on the handheld device.

3) Software to create efficient data connections

4) Database service and web-based database software products

The diagram in FIG. 4 is a simple system representation. Contained within the Internet cloud are the routers and access devices that create the connections throughout the network.

The reader and associated RFID tags will operate in a local environment. It is important to understand the range and access capabilities of the reader when operating with the tags. In general, as the environment changes, it may necessary to reduce the RF power, and thereby, reduce the number of available tags to the reader. This will be both automatically adjusted or user adjusted to allow the user to simplify the number of available choices, if necessary.

The reader will be developed to be added onto existing handheld devices available in the market today or can be integrated into new devices. Integration of the reader into existing functional devices such as Bluetooth or 802.11 will be a key advantage, as these devices are being integrated or offered in this product category. In fact, with minimal modifications to existing circuitry, it is possible to re-use device attributes from either 802.11 or Bluetooth or Ultra-Wide-Band (UWB) systems, for RFID tags in the 2.4 GHz range or use the cellular device in the 900 MHz and 2.4 GHz range. These are target applications for the handheld devices this business will target. In this application, then, it is possible to also offer high speed data links for the handheld device integrating this technology. This novel integration of functions and expansion capabilities of the local environment is an advantage of this system

Additionally, the reader will be available in several form factors. This includes plug-in modules to existing handheld phones, PDA plug-in modules, devices for integration (IP blocks), or integration into smart card/memory card formats. This last category of integration allows access for many types of handheld devices.

Resident within a reader enabled handheld device, client software will be operating. This software will work within the operating system (such as BREW, JAVA) of the handheld device. This client will be available as a software download and is designed as a Java application, for example. The client enables the interaction to both the RFID reader and the wireless internet domain. Within this module, the data (for example stored in XML format on the tag or in a non resident database) will be processed and presented to the user for review or further action. Also, in the background, the client takes the data of the product, along with additional information and creates the appropriate seamless link for the user. As the user traverses the menu tree, the seamless connection allows that user to access data across environment domains, with increasing content capability including the capability to create a transaction for a purchase. The client itself uses secure software techniques to protect any sensitive information within each domain, as is necessary. For the local environment, limited or no security is required, as the user is has direct control over the access to data and the use of this data. As the environment changes from the local domain to the wireless access point and onto the internet, both secure and non-secure informational text and secure transactional information are required. Further, the seamless link will take advantage of the mobile IP capabilities available in the wireless network today. Mobile IP in the past has been somewhat cumbersome, but this automatic link creation and anticipation created by the client increases the usability to the system. The client software will drive the display as required to allow for user choices and will allow configuration control of the application. This client is specific to the handheld device only and enables operation across all environments.

To support content in the local environment it may be necessary to update information contained on the RFID tag. The data on the tags will contain multiple levels of information. For example, the manufacturer will add information specific about the product or add data for seamless connections to more data. As the tag moves through different points of the retail chain, additional information can be added to create alternate levels of access. For example, the retailer may want to add store information and seamless connection to retail information. Either party can then create instantaneous information to enhance the purchasers' decision as discussed previously. As this re-uses known radio links such as the 802.11 or Bluetooth or cellular CMDA radio, it also allows for a local wireless link to be created for in-store transactions from the handheld device.

It is appropriate then to develop and offer multiple levels of service and software to support the many varied applications for this business. Our client software will reside in many parts of the system, offering these unique marketing capabilities. Software clients/applications will be available for the manufacturer and retailer to access data bases of product information or content (possibly stored in XML format for example), included in this will be the capability to format, design and scale the content to work reliable with the limited displays available on handheld devices. Also, this software will be secure and capable of conducting transactions directly to these entities. Software will be made available to format the data and program devices from any access point. Agreements between retailers and manufacturers can then be constructed to allow direct access to products in retail outlets to program marketing content. And of course there is the client software in the handheld device.

It was demonstrated that a technology could be developed to deliver new and unique products and services to the consumer. The system is flexible and lends itself to leverage future technical advances enhancing the capabilities and potential of the entire system allowing ongoing revenue sources, also the applications and flexibility of this system is substantial allowing adaptation to meet a variety of customer and consumer needs.

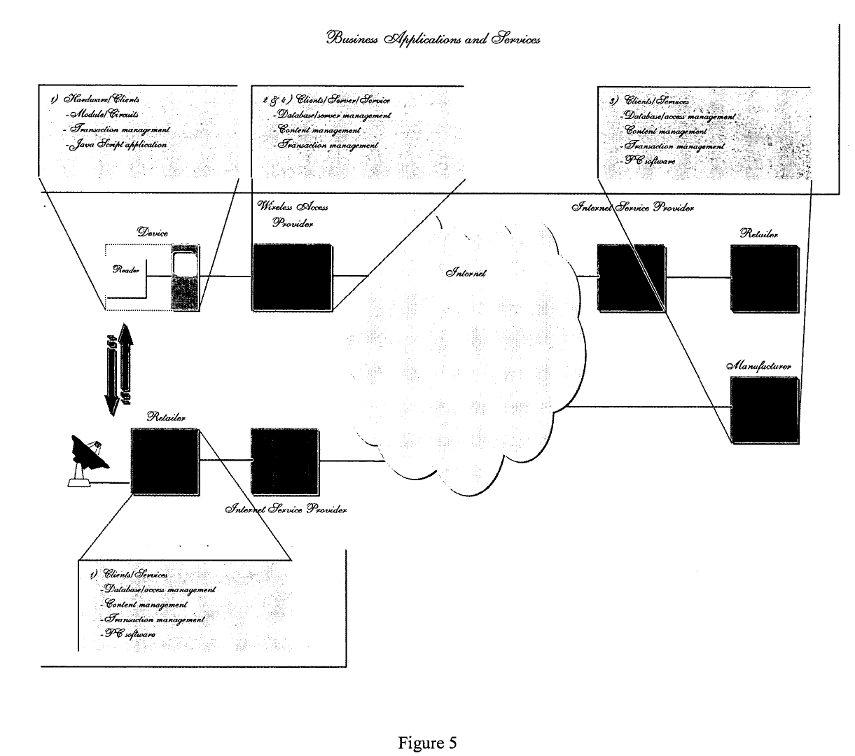

First, the system diagram will be used to identify products and discuss revenue models. This can be generally divided into the following partitions as shown in FIG. 5:

Hardware modules, chips, circuits, clients, and IP to support the handheld reader (Core Technology Business).

Local environment software clients, PC software, network software and marketing services for the retailer (Local Environment Applications Business).

Global environment marketing service, network software for the retailer or manufacturer (Manufacturing Solutions Business).

Content server software/hardware for the wireless access provider or application service provider (Provisioning Solutions Business).

Referring to the FIG. 5, the first area to consider is the reader itself, the modules, circuits, clients and intellectual property licensing. The first goal is to create a community of handheld devices that have the capability to access RFID tags and create the appropriate links to drive the content server. This can be achieved in several methods. First, completely new modules are created that clip, interface, or integrate to a handheld device. The users will be able to access this capability directly from their handheld devices and download the client from a web-server.

It is important to recognize some of the transactions that take place within the environments and possible alternative capabilities never before available. In general, each entity will benefit from the increased service capabilities.

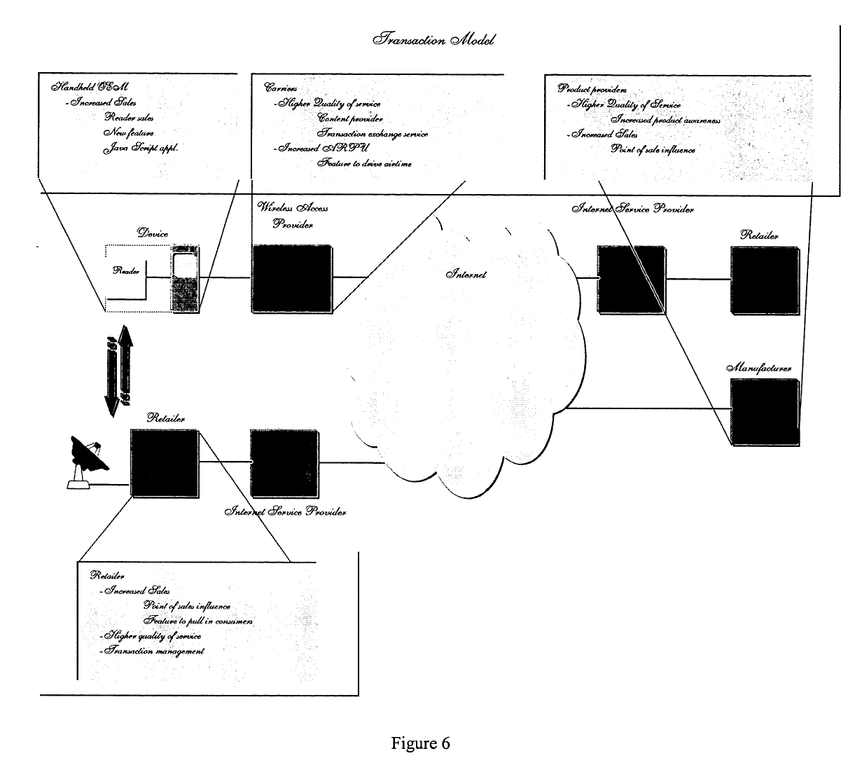

One of the most important features is the ability to provide the individual consumer with information at the time of a purchase decision as outlined in FIG. 6. The goal of the retailer is to increase sales, while the goal of the manufacturer would be to influence the product selection. The service provider would benefit through increased usage on their system and access to the mobile consumer. The mobile consumer benefits by obtaining information pertaining to desired decision points and the satisfaction of making an educated purchase.

Although the invention has been described in terms of exemplary embodiments, it is not limited thereto. It will also be appreciated that a system in accordance with the invention can be constructed in whole or in part from special purpose hardware or from conventional general purpose hardware or any combination thereof, any portion of which may be controlled by a suitable program. Any program may in whole or in part comprise part of or be stored on a system in a conventional manner, or remain whole or in part be provided into the system over a network or other mechanism for transferring information in a conventional manner. Accordingly, it is understood that the above description of the present invention is susceptible to considerable modifications, changes and adaptation by those skilled in the art, and that such modifications, changes and adaptations are intended to be considered within the scope of the present invention, which is set forth by the appended claims. The invention having been described, it will be apparent to those skilled in the art that the same may be varied in many ways without departing from the spirit and scope of the invention. Any and all such modifications are intended to be included within the scope of the following claims.

1. A system for accessing and displaying data through a portable wireless device by creating a wireless link that is configured at a location for a product or service of interest, comprising:
a wireless identification tag containing information regarding a product or service;
a first wireless interface for accessing the information contained in the wireless identification tag; and
a second wireless interface for accessing or connecting to other remote information.

2. A system of claim 1, wherein the second wireless interface comprises one or more selected from the group consisting of GSM, CDMA, W-CDMA, OFDM, UWB, 802.11, 802.16, 802.1x, WiMax, ZigBee and Bluetooth.

3 A system of claim 1, wherein the second wireless interface accesses data through the internet.

4 A system of claim 1, wherein the first and second wireless interfaces are derived substantially from the use of the same components comprising one or more selected from the group consisting of antenna, amplifier, mixer, LNA, VCO, receiver, transmitter.

5. A method for creating a data link through a portable wireless device comprising:
acquisition of configuration information through interrogation of one or more radio frequency devices;
concatenation of information from one or more devices;
display of information from one or more devices;
creation of a link to access data from a remote database through one or more wireless interfaces; and
association of location for a product or service to data through creation of a link.

6. A method for storing information from reading of radio frequency storage devices comprising:
acquisition of data information through interrogation of one or more radio frequency devices
creating a link to information;
reviewing the information for comparison;
allowing the information to be carried away from a point of sale;
displaying the product or service information at a later time; and
retaining a history of the information.

7. A method of claim 5 further comprising:
data that allows client software contained in the portable device to seamlessly negotiate through the wireless link to address additional information.

8. A method of claim 6 further comprising:
data that allows client software contained in the portable device to seamlessly negotiate through the wireless link to address additional information.

9. A method of claim 8 for storing information from reading additional information comprising:
acquisition of data information through one or more wireless interface
accessing and displaying the information;
reviewing the information for comparison;
allowing the information to be carried away from a point of sale;
displaying the product or service information at a later time; and
retaining a history of the information.

10. A portable wireless device with cellular capability that can interrogate/read radio frequency identification devices and operate interactively comprising accessing data through at least one of a wireless link or a radio frequency identification device or tag.

11. A portable wireless device of claim 10, wherein the cellular capability comprises one or more selected from the group consisting of GSM, CDMA, W-CDMA, OFDM, UWB, 802.11, 802.16, 802.1x, WiMax, ZigBee and Bluetooth.

12. A portable wireless device of claim 11 further comprising a reader comprising a plug-in module for connection to a communication device selected from the group consisting of handheld phones, PDA plug-in modules, devices for integration (IP blocks), or integration into smart card/memory card formats.

13. A method to create a data link based upon information in the radio frequency identification tag comprising:
displaying information directly contained in the ID;
displaying information indirectly through information in the ID that connects to a non-resident database;
an EPC code to create a link to the non-resident data; and
creating access to layers of information through successive links contained in the data.

14. A method of claim 13 further comprising client software residing on the handheld device and to create efficient data connections.

15. A method of claim 14 further comprising the ability to scan the general vicinity to identify location of items

16. A method of claim 13 further comprising storage of an IP address or data form in the radio frequency identification tag adapted to connect to the non-resident data.

17. A method of claim 13 further comprising concatenation of at least one of IP address or data form to EPC (electronic product code) in radio frequency identification tag.

18. A mechanism to create marketing services based upon user choices comprising:
interactive messaging through successive layers of data links and selections;
access to discounts or promotional information relating to designated products or services;
substantially instantaneous interaction created through links created from RFID information.

19. A mechanism of claim 18, wherein the substantially instantaneous interaction comprises one or more selected from the group consisting of looking up the information, connecting information/data to the user, tracking of selections or providing a marketing path.

20. A mechanism of claim 18, wherein access to discounts or promotional information comprises one or more selected from the group consisting of discount through e-coupon displayed as barcode for scanning or transfer of the e-coupon wirelessly into the system.

21. A mechanism of claim 18, wherein the marketing services comprises one or more products or services selected from the group consisting of wine, real estate, mall map, automobiles, audio samples, video samples, museum tours, magazine samples, book samples, pharmacy, video game, nursery, or grocery store.
